(19) United States
(12) Patent Application Publication
(10) Pub. No.: US 2007/0153122 A1
(43) Pub. Date: Jul. 5, 2007

(54) APPARATUS AND METHOD FOR SIMULTANEOUS MULTIPLE VIDEO CHANNEL VIEWING

(76) Inventors: Nii Ayite Ayite, Philadelphia, PA (US); Zereyacob Girma, Philadelphia, PA (US); Aung Sis Naing, Philadelphia, PA (US)

Correspondence Address: DESIGN IP, P.C., 5100 W. TILGHMAN STREET, SUITE 205, ALLENTOWN, PA, 18104, US

(21) Appl. No.: 11/306,511

(22) Filed: Dec. 30, 2005

(51) Int. Cl. H04N 13/04; H04N 11/02

(52) U.S. Cl. 348/385.1; 348/55

(57) ABSTRACT

A multiplexer interlaces first and second video signals to form a third video signal comprising fields from the first and second video signals in alternating sequence. A filter system enables a first person, when viewing the third video signal, to see the first video signal but not the second video signal and a second person, when viewing the third video signal simultaneously with the first person, to see the second video signal but not the first video signal.

### BACKGROUND OF THE INVENTION

The invention relates to devices and methods for processing video and audio signals and, more specifically, devices that enable two people to simultaneously view different channels displayed full-screen on a single display surface.

Both the increasing popularity of multi-player video gaming systems and the ever-increasing number of television channels available through cable and satellite television systems have led to the desirability for multiple persons to view more than one channel simultaneously. In the case of multi-player gaming systems, multi-player games are often accommodated by using a split screen in which a portion of the screen shows one player's perspective and another portion of the screen shows another player's perspective. In the context of conventional television viewing, picture-in-picture technology allows multiple channels to be viewed at once. The secondary channel, however, is shown in a small fraction of the screen area and does not include audio.

### SUMMARY OF THE INVENTION

The invention comprises an apparatus and method for enabling multiple viewers to each view different channels on a single video display.

In one respect, the invention comprises a multiplexer that interlaces a first video signal and a second video signal to generate a third video signal. The first video signal comprises a first series of fields and the second video signal comprising a second series of fields. A filter system is also provided that is adapted to enable a first person, when viewing a display surface displaying the third video signal, to see the first series of fields but not the second series of fields and a second person, when viewing the display surface simultaneously with the first person, to see the second series of fields but not the first series of fields.

In another respect, the invention comprises an apparatus comprising means for displaying first and second video signals full screen on a display surface. The first video signal comprises a first series of fields and the second video signal comprises a second series of fields. Fields from the first series of fields are displayed either simultaneously or in alternating sequence with fields from the second series of fields on a display surface. A filter system is provided that is adapted to enable a first person, when viewing the display surface, to see the first series of fields but not the second series of fields and is adapted to enable a second person, when viewing the display surface simultaneously with the first person, to see the second series of fields but not the first series of fields.

In yet another respect, the invention comprises an apparatus having a synch separator that obtains timing information from at least one of a first and second video signals, wherein the first video signal comprises a first series of fields and the second video signal comprises a second series of fields. The first video signal includes a corresponding first audio signal and the second video signal includes a corresponding second audio signal. The apparatus also includes a control unit that uses the timing information obtained by the synch separator to generate a control signal, a multiplexer that utilizes the control signal to interlace the first video signal and the second video signal to generate a third video signal and a filter system that is adapted to enable a first person, when viewing a display surface displaying the third video signal, to see the first series of fields but not the second series of fields and to hear the first audio signal and not the second audio signal and a second person, when viewing the display surface simultaneously with the first person, to see the second series of fields but not the first series of fields and to hear the second audio signal and not the first audio signal.

In yet another respect, the invention comprises a method of displaying a first video signal having a first set of fields and a second video signal having a second set of fields. The method comprises interlacing the first and second video signals to form a third video signal that comprises a third series of fields, the third series of fields consisting of the first and second series of fields in alternating sequence. The method also comprises filtering the third signal so that a first person, when viewing a display surface displaying the third video signal, to able to see the first series of fields but not the second series of fields and a second person, when viewing the display surface simultaneously with the first person is able to see the second series of fields but not the first series of fields.

### BRIEF DESCRIPTION OF THE DRAWINGS

FIG. 1 is a block diagram of a first embodiment of the invention which comprises a signal processing device is intended for use with a multi-channel signal;

FIG. 2 is a graph showing the vertical sync signals of channel A and channel B prior to time-base correction;

FIG. 3 is a graphs showing the vertical sync signals of channel A and channel B after time-base correction;

FIG. 4 is a graph showing the timing relationships between the display of channels A and B and the control signals for shutter glasses A and shutter glasses B;

FIG. 5 is a graph showing the relationship between the vertical sync signal from channel A and the multiplexer control sync signal;

FIG. 6 is a block diagram showing a second embodiment of the invention, which comprises a software-based signal processing device;

FIG. 7 is a block diagram of a third embodiment of the invention, which comprises a hardware-based signal processing device adapted for use with a video gaming system;

FIG. 8 is a block diagram of a fourth embodiment of the invention, which comprises a signal processing device that utilizes a polarized dual-projector configuration;

FIG. 9 is a block diagram of a fifth embodiment of the invention, which comprises a variation of the first embodiment in which a polarizing layer is placed in front of the display surface; and

FIG. 10 is a block diagram showing sync-doubler.

### DETAILED DESCRIPTION OF THE PREFERRED EMBODIMENTS

The principles and operation of the signal processing device of the present invention are better understood with reference to the drawings and the accompanying description. In order to aid in understanding of the invention, reference numerals that are referred to in the specification with respect to one or more figures may appear in additional figures without a specific reference to such additional figures in the specification.

Broadly stated, the invention comprises a system that enables viewers to see different video channels on the same video display simultaneously and in full-screen format. As will be described in detail with respect to the embodiments disclosed herein, the system comprises two primary functional components: (1) a signal processing device that modifies multiple input channels and generates at least one output video signal, and (2) a filtering unit that, for each viewer, filters out all but one video channel. The system of the present invention can be provided as an add-on feature to existing video sources, such as DVD players, cable television service, video gaming consoles, etc., or integrated into such sources.

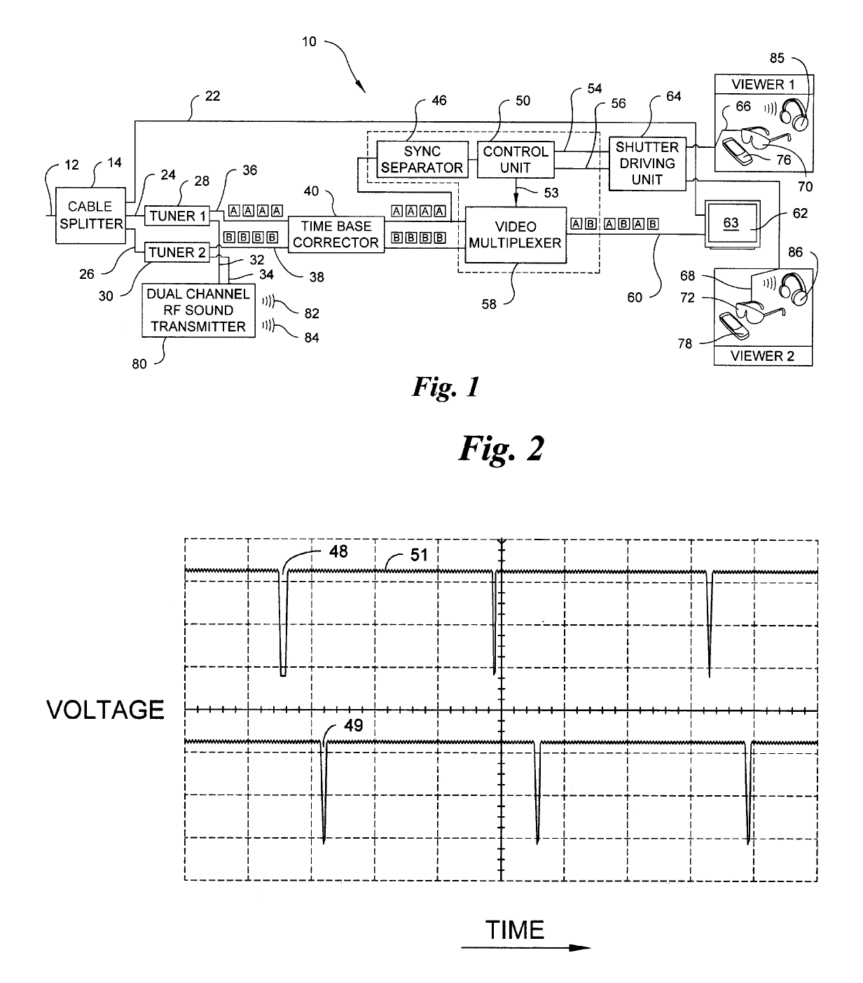

Referring to FIG. 1, reference numeral 10 refers generally to a first embodiment of the signal processing device 10 of the present invention. This embodiment is intended to process an analog multi-channel NTSC signal source. There are many other audio/video signal standards currently in use, including analog signal standards such as analog phase alternation by line (PAL) and sequential color with memory (SECAM), as well as digital signal standards such as Advanced Television Systems Committee (ATSC), digital video broadcasting (DVB) and integrated services digital broadcasting (ISDB). The devices and methods described herein can be adapted to accommodate any of these signal standards, as well as signal standards which will undoubtedly be developed in the future.

The source signal is connected to a signal input jack 12 and is then passed through a one-to-three cable splitter 14 which splits the multi-channel signal three ways, into multi-channel signals 22, 24, 26. Multi-channel signal 22 is an optional by-pass which enables the display 62 to be used to display a single channel in a conventional manner.

Multi-channel signals 24 and 26 are each connected to first and second tuners 28, 30. The tuners 28, 30 each extract single-channel video and audio signal from the multi-channel signals 24, 26. In order to clearly identify each output signal, the single-channel video signal output of the first tuner 28 will be referred to as the alpha video signal 36, the single-channel audio signal out put of the first tuner 28 will be referred to as the alpha audio signal 32, the single-channel video signal output of the second tuner 30 will be referred to as the beta video signal 38, the single-channel audio signal out put of the second tuner 30 will be referred to as the beta audio signal 34. The terms “alpha” and “beta” (which are interchangeably used in the specification and drawings with “A” and “B”) are used herein to simplify the identification of components that process alpha or beta signals, as well as the various signals that are related to either the alpha or beta single-channel video signal.

The tuners 28, 30 are preferably an integrated part of the signal processing device 10. In this embodiment, the circuitry of each tuner 28, 30 is preferably similar to that of a stand-alone tuner, such as Grandtec USA's Model Tun-2000 tuner, for example. The channels to be extracted by the tuners 28, 30 can be determined and changed by any number of conventional means, such as a control panel located on the device 10 (not shown) and/or wireless remote controls 76, 78.

The alpha and beta video signals 36, 38 each comprise a series of fields (represented by the squares containing the letters A or B in the drawings and referred to herein as “alpha fields” and “beta fields,” respectively). In conventional NTSC systems, each of these fields represents every other line of a complete video frame, the first field including the odd lines (usually horizontal) and the second field including the even lines. Due to the speed at which the fields are displayed on the display surface 63 of the video display 62, the frames appear to the human eye as complete frames. The standard field refresh rate for NTSC video signals is approximately 60 Hz, which corresponds to a frame refresh rate of 30 Hz.

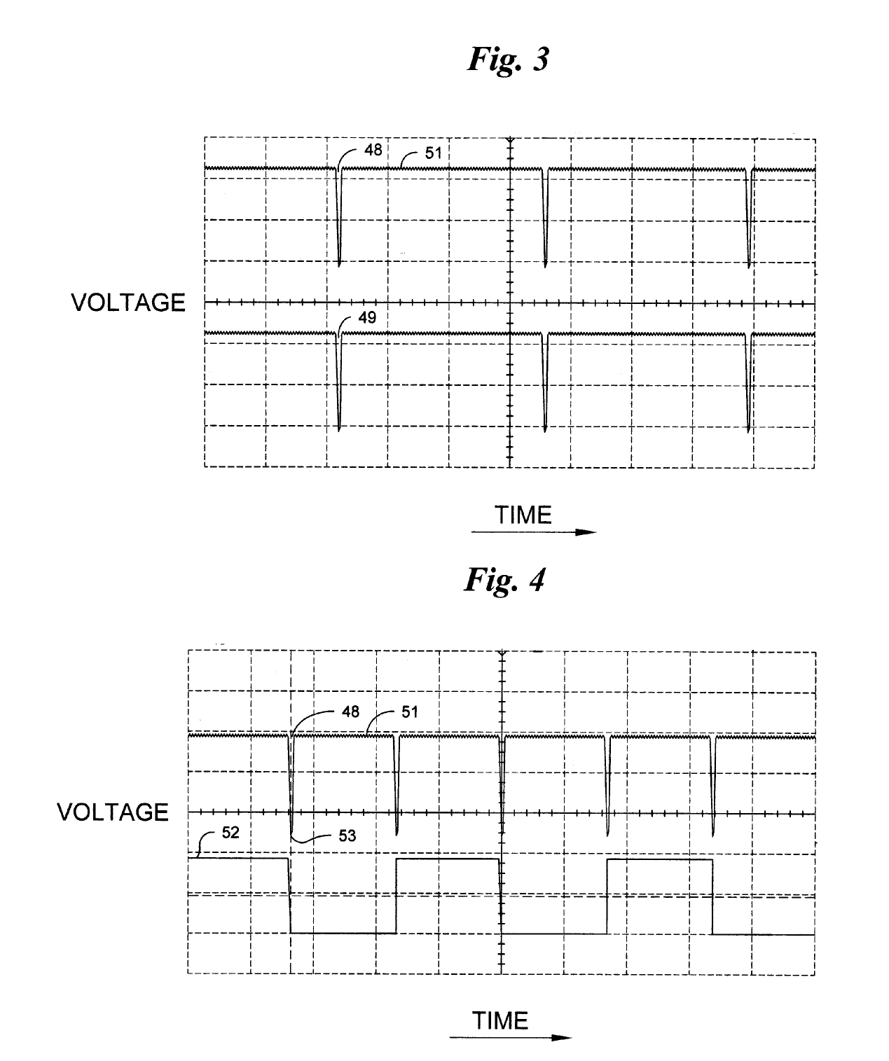

Referring now to FIG. 2, the alpha and beta video signals 36, 38 each include a vertical sync pulse 48, 49, which represents the conclusion of each field. As can be seen in FIG. 2 and is schematically represented in FIG. 1, the vertical sync pulses 48, 49 are not synchronized. This is common in different channels extracted from analog multi-channel NTSC signals. In order to interlace the alpha and beta channels, it is desirable to first synchronize the vertical sync pulses 48, 49. In this embodiment, the alpha and beta video signals 36, 38 are passed through a time base corrector 40, which synchronizes the vertical sync pulses 48, 49. The time base corrector 40 is preferably an integrated part of the signal processing device 10. In this embodiment, the circuitry of the time base corrector 40 is preferably similar to that of stand-alone time base correctors, such as a Datavideo Corporation model TBC-3000 dual-channel time base corrector, for example. FIG. 3 shows the vertical sync pulses 48, 49 of the alpha and beta video signals 36, 38 after being synchronized by the time base corrector 40.

After being synchronized, the alpha and beta video signals 36, 38 are processed by a video multiplexer 58. The video multiplexer 58 generates an output video signal 60 (FIG. 1) which consists essentially of the interlaced fields of the alpha and beta video signals 36, 38. Stated another way, the fields of the alpha and beta video signals 36, 38 are arranged in alternating sequence in the output video signal 60, as shown schematically in FIG. 1.

In this embodiment, the video multiplexer 58 is preferably an integrated circuit (IC) having a multiplexer chip and an amplifier that acts as a low-impedance line driver. A Maxim model MAX453 two-way multiplexer chip is an example of a suitable IC multiplexer chips for this embodiment. In order to properly interlace the alpha or beta video signals 36, 38, a multiplexer control signal 52 that is properly synchronized with the vertical sync of either the synchronized alpha or beta video signals 36, 38 must be provided to the multiplexer chip. The multiplexer chip used in the embodiment requires a +5V and −5V control signal.

In this embodiment, the multiplexer control signal 52 is provided by a control unit 50 which generates the control signal 52 from the vertical synch pulse 48 of the alpha video signal 36. A vertical sync signal 51, which contains the vertical sync pulse 48, is extracted from the alpha video signal 36 by a sync separator 46. In this embodiment, the synch separator 46 is an integrated circuit built onto the same printed circuit board (PCB) as the video multiplexer 58 and the control unit 50. Sync separators (also called sync extractors) are known in the art. An Elantec model EL1881CN sync extractor, for example, could be used in this embodiment. The control unit 50 is comprised of a falling-edge triggered master-slave D flip flop circuit, which generates square-wave output signals. One output signal, multiplexer control signal 52, is fed to both the video multiplexer 58. Two other output signals, shutter control signals 54, 56, are passed to a driving unit 64 for the shutter glasses 70, 72, all of which will be described in greater detail herein.

FIG. 4 shows the control signal multiplexer control signal 52 generated by the control unit 50 from the alpha vertical sync signal 51 and the time relationship between the two signals. As shown in FIG. 4, the multiplexer control signal 52 switches alternately between +5V and 0V at the falling edge 53 of each vertical sync pulse 48.

In this embodiment, the video display 62 is a standard television having a display surface 63 and has a fixed 60 Hz field refresh rate. If every field from the alpha and beta signals 36, 38 were included in the output video signal 60, the field refresh rate would be 120 Hz, which cannot be supported by a standard CRT television. Therefore, in this embodiment, every other field from each of the alpha and beta video signals is dropped (i.e., not included) in the output video signal 60. In applications of the present invention in which the video display has a maximum field refresh rate that is at least twice the field refresh rate of the alpha and beta video signals 36, 38, all of the fields can included in the output video signal 60.

When fed to the video display 62, the output video signal 60 causes the fields shown in the display surface 63 to rapidly alternate between fields from the alpha video signal 36 and fields from the beta video signal 38. In order to enable a viewer to see only one of the channels that are interlaced into the output video signal 60, a filter system is required. In this embodiment, the filtering system comprises liquid crystal shutter glasses 70, 72 and a shutter driving unit 64.

Liquid crystal shutter glasses 70, 72, such as those provided in an I-O Display Systems I-ware 3D system, for example, are widely available and have been previously used in the art to view stereoscopic (3D) images on a conventional CRT monitor or other non-polarized video display. The lenses of the shutter glasses 70, 72 include a twisted nematic liquid crystal layer sandwiched between front and rear cross-oriented polarizing layers. Light is polarized as it passes through the front polarizing layer. When no electrical current is applied to the liquid crystal layer, the liquid crystal layer rotates the axis of polarization of the light by 90 degrees, which orients the light so that it can pass through the rear polarizing layer. This will be referred to herein as the “open” or substantially transparent state. When a current is applied to the liquid crystal layer, the liquid crystal does not rotate the axis of polarization of the light. Therefore, the axis of polarization of the light is perpendicular to the rear polarization layer and the light will be blocked by the rear polarization layer. This will be referred to herein as the “closed” or substantially opaque state.

CRT video display devices and other video displays that emit non-polarized light are well-suited for use with liquid crystal shutter glasses 70, 72. Video displays that emit polarized light, such as HDTV and LCD video displays, can be used with liquid crystal shutter glasses 70, 72, but the viewers must keep the glasses 70, 72 in an upright position.

The function of the shutter driving unit 64 is to amplify the shutter control signals 54, 56 to fall within the preferred input signal parameters of the shutter glasses 70, 72. In this case, the alpha and beta shutter control signals 54, 56 are transformed to square waves alternating between ten and zero volts, which are passed to the alpha and beta shutter glasses 70, 72 and alpha and beta shutter control sync signals 66, 68, respectively. The shutter glasses 70, 72 can be wired, as shown in FIG. 1, or wireless. If the shutter glasses 70, 72 were wireless, the driving unit 64 would emit a signal, such as an infra-red (IR) signal for each pair of shutter glasses 70, 72.

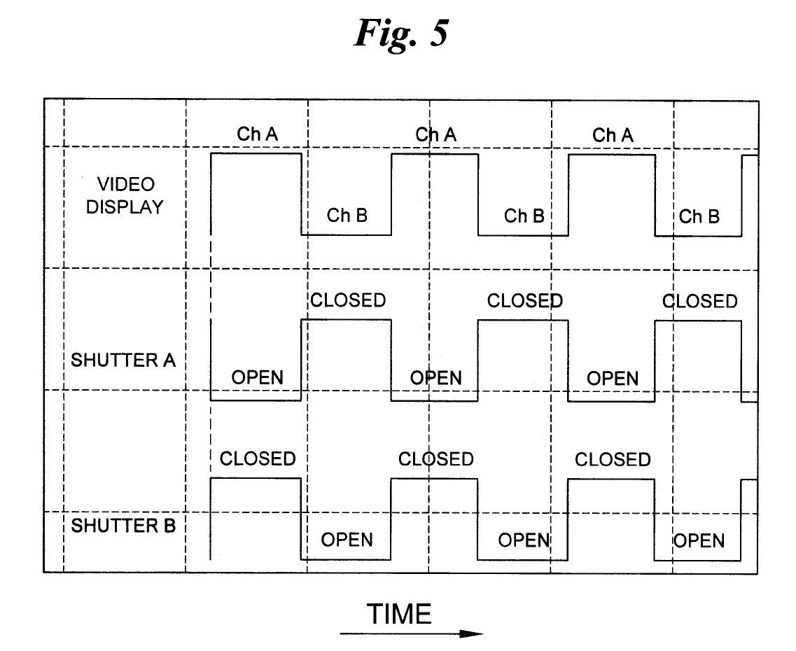

FIG. 5 schematically shows the timing relationship between alpha and beta fields in the interlaced output signal 60 and the alpha and beta shutter sync signals 66, 68. During the time period in which each alpha field will be displayed, the alpha shutter sync signal 66 is at zero volts, which means that the alpha shutter glasses 70 are in the open state (substantially transparent state), and the beta shutter sync signal 68 is at ten volts, which means that the beta shutter glasses 72 are in the closed state (substantially opaque state). Thus, if a first viewer 1 wears the alpha shutter glasses 70 and looks at the video display surface 63 when the interlaced output video signal 60 is being displayed thereon, he or she will only see fields from the alpha video signal and will not see fields from the beta video signal. Conversely, if a second viewer 2 wears the beta shutter glasses 72 and looks at the video display surface 63 when the interlaced output video signal 60 is being displayed thereon, he or she will only see fields from the beta video signal and will not see fields from the alpha video signal.

This embodiment of the signal processing device 10 can be easily adapted to accommodate additional viewers by simply adding additional shutter glasses and having each shutter sync signal transmitted to more than one pair of shutter glasses.

Referring again to FIG. 1, it is also desirable for the first viewer 1 to hear the alpha audio signal 32, but not the beta audio signal 34 and for the second viewer 2 to hear the beta audio signal 34, but not the alpha audio signal 32. In this embodiment, this is accomplished using a multi-channel radio frequency (RF) transmitter 80 paired with alpha and beta headphones 85, 86, which are configured to receive RF signals on different frequencies. The alpha and beta audio signals 32, 34 are passed to the RF transmitter 80, which are converted to wireless RF signals and are transmitted as alpha and beta RF signals 82, 84. The alpha headphones 85 are configured to receive the alpha RF signal 82 and the beta headphones 86 are configured to receive the beta RF signal 84. Any suitable type of wireless transmission method, such as IR or Bluetooth, could be used instead of an RF signal. In low-cost embodiments of the invention, the headphones 85, 86 could also be wired.

Alternatively, multi-channel directional sound generation could be used instead of the RF transmitter 80 and headphone 85, 86. This type of audio generation would have the advantage of not requiring the use of headphones, but would require viewers to be positioned within the respective areas in which the alpha and beta audio signals 32, 34 are directed.

Many alternative embodiments of the signal processing device 10 are possible. For example, the signal processing device 10 could be adapted to comprise a built-in portion of an audio-visual device, such as a video gaming console or a set-top cable television box.

The signal processing device 10 includes analog components which process an analog input signal (signal 12) and produce an analog output signal (signal 60). It should be understood that a corresponding digital hardware component or programmable digital software component could be substituted for most of the analog components used in any of the embodiments of the invention described herein. In addition, any of the embodiments described herein could be adapted to accept digital signal input(s) and/or digital signal output(s).

Analog-to-digital and digital-to-analog converters can be used to enable an analog signal to be processed by a digital component (or vice versa), or when it is desirable to convert an input or output signal to analog or digital. For example, an analog-to-digital converter could be used to enable a digital time base corrector to process an analog signal. If desired, a digital-to-analog converter could be included to convert the digital output signal back to analog. In some applications, such as those in which digital input signals are provided, the tuners 28, 30 and the time base corrector 40 could be omitted.

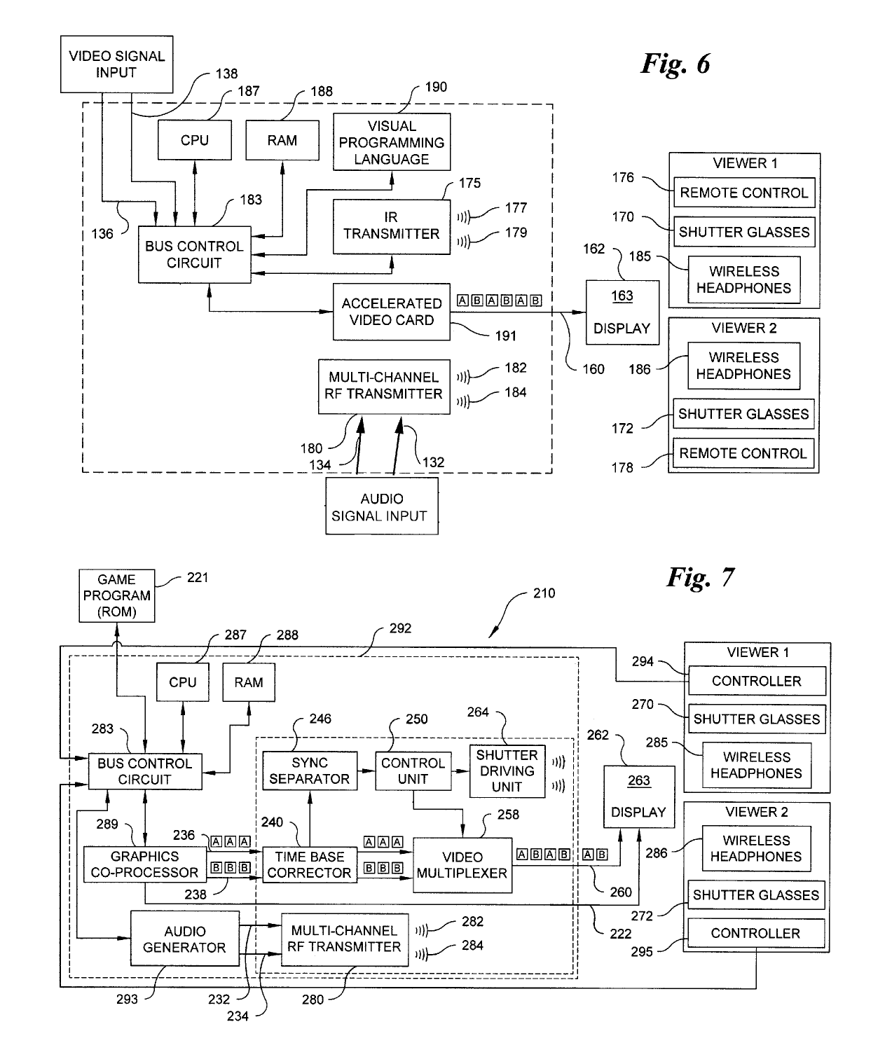

A second embodiment of the signal processing device 10 is shown in FIG. 6 and represented by reference numeral 110. In this embodiment of the present invention, elements that correspond to elements in the first embodiment (signal processing device 10) are represented by reference numerals increased by factors of 100. For example, the display 62 in FIG. 1 corresponds to the display 162 in FIG. 6. In the interest of brevity, some features of this embodiment that are shared with the first embodiment may be numbered in FIG. 6, but not repeated in the specification.

This embodiment is essentially a software-based implementation of the first embodiment, in which the functions of the time-base corrector 40, video multiplexer 58, sync extractor 46, control unit 50 and shutter driving unit 64 are performed using a programmable computer 174. As is conventional, the computer 174 includes a bus control circuit 183, a central processing unit (CPU) 187, and random access memory (RAM) 188. The computer 174 also includes graphics application programming interface (API) software 190, such as OpenGL or Direct3D, and a graphics card 191. The API software 190 is used to command the graphics card 191, which, in turn, synchronizes and interlaces alpha and beta video signals 136, 138. The alpha and beta video signals 136, 138 must be in digital format or be converted to digital format using an analog-to-digital converter. The graphics card is used to interface with the shutter glasses 170, 172. The programming necessary to produce an interlaced output signal 160 from alpha and beta video signals 136, 138, using the API software 190 and graphics card 191 is very similar to the programming used for stereovision implementations, which is known in the art.

The graphics card 191 preferably includes digital components necessary to perform the synchronizing and interlacing functions, including a digitizer/decoder, RAM, a processor, a sync separator, a timing generator, a video encoder and a tuner. Alternatively, an external tuner could be provided. Stereoscopic accelerator cards are known in the art and typically include these components. If the graphics card 191 does not include RAM and/or a processor, the RAM 188 and CPU 187 of the programmable computer 174 could be used instead.

In a typical digital environment, audio and video signals are provided separately, which eliminates the need to separate the audio and video signals. In this embodiment, alpha and beta audio signals 132, 134 are passed directly to a multi-channel RF transmitter 180. The RF transmitter 180 transmits alpha and beta RF audio signals 182, 184 to alpha and beta headphones 185, 186, respectively.

In this embodiment, the shutter glasses 170, 172 are wireless. An infrared (IR) transmitter 175 is preferably also provided to transmit alpha and beta IR signals 177, 179 to the alpha and beta shutter glasses 170, 172, respectively. Obviously, wireless or wired shutter glasses can be used interchangeably any of the embodiments of the invention described herein.

The software-based embodiment of the signal processing device 110 is capable of producing an interlaced output signal 160 having a field-refresh rate of 120 Hz. Doubling the field-refresh rate is made possible by using a memory usage method known as “quad buffering,” which is currently used in stereoscopic digital video applications. Quad buffering makes use of two memory buffers for each video channel, which enables multiple channels to be interlaced without dropping fields. As video displays that support 120 Hz field-refresh rates, such as LCD and HDTV video displays, become more widely used, a 120 Hz interlaced output signal 160 can be used in applications in which the video display can support 120 Hz field-refresh rates.

A third embodiment of the signal processing device 10 is shown in FIG. 7 and is represented by reference numeral 210. In this embodiment of the present invention, elements that correspond to elements in the first embodiment (signal processing device 10) are represented by reference numerals increased by factors of 200. For example, the video multiplexer 58 in FIG. 1 corresponds to the video multiplexer 258 in FIG. 7. In the interest of brevity, some features of this embodiment that are shared with the first embodiment may be numbered in FIG. 7, but not repeated in the specification.

This embodiment of the invention is a signal processing device 210 that is adapted for use with a video gaming console 292, such as a Sony Playstation 2 gaming console or Microsoft X-Box gaming console. Multiplayer games are very popular with users of conventional video gaming consoles. When playing a multi-player game on a single conventional video gaming console, the video signal shown on the video display surface 263 must be divided into multiple partial-screen windows (one for each player). When a multi-player game is played using multiple linked video gaming consoles, a separate video display is required for each video gaming console. This embodiment of the invention allows each player in a multi-player game to view his or her perspective in full-screen mode on a single video display, using either one or multiple video gaming consoles.

As is conventional, the video gaming console 292 includes a bus control circuit 283, a CPU 287, a graphics co-processor 289, RAM 288, an audio generator 293, and a game program 221. The game program 221 is typically an optical drive designed to read compact disks or digital video disks containing game data. Multiple controllers are provided with conventional gaming consoles and are used by viewers/players to control video game action. In the interest of simplicity, only two controllers, an alpha controller 294 and a beta controller 295, are illustrated in FIG. 7. Video gaming consoles 292 are commonly capable of accommodating up to four controllers.

In this embodiment, the functional components of the signal processing device 210 are very similar to the first embodiment of the signal processing device 10 shown in FIG. 1. The graphics co-processor 289 generates two single-channel video signals, an alpha video signal 236 and a beta video signal 238, which eliminates the need for tuners. The alpha and beta video signals 236, 238 are passed from the graphics co-processor 289 to a time base corrector 240, after which the signals 236, 238 are interlaced using the same components and method as in the first embodiment. In addition, this embodiment uses the same filtering system, including shutter glasses 270, 272, as is used in the first embodiment. The shutter glasses 270, 272 are wireless in this embodiment. A shutter driving unit 264 having IR capability (as described with respect to the first alternate embodiment) is preferably provided. This embodiment also preferably includes video by-pass 222, which allows the video gaming system to be used in a single channel mode.

In this embodiment, it is assumed that the alpha and beta video signals 236, 238 generated by the graphics co-processor 289 are analog. If the alpha and beta video signals 236, 238 generated by the graphics co-processor 289 are digital (instead of analog), the time base corrector 240 would likely not be necessary and corresponding digital components would be preferably substituted for the sync separator 246, control unit 250, video multiplexer 258 and shutter driving unit 264. Alternatively, analog components could be used if a digital-to-analog converter is provided.

The audio generator 293 generates alpha and beta audio signals 232, 234, which correspond to the alpha and beta video signals 236, 238, respectfully. As in the first embodiment, the alpha and beta audio signals 232, 234 are passed to a multi-channel RF sound transmitter 280 which, in turn, generates alpha and beta RF sound signals 282, 284. The alpha and beta RF sound signals 282, 284 are received by alpha and beta headphones 285, 286, respectively. This enables viewer 1 to hear only the alpha audio signal 232 and viewer 2 to hear only the beta audio signal 234.

In this embodiment, the signal processing device 210 Is shown as being an integral part of the video gaming console 292. Alternatively, the signal processing device 210 could be provided as an add-on module to be used with either a single existing video gaming console or even multiple video gaming consoles.

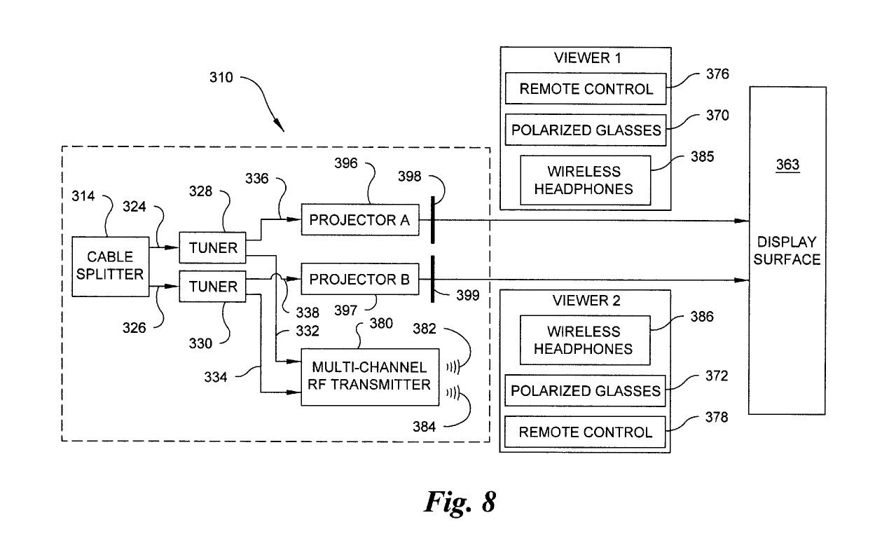

A fourth embodiment of the signal processing device 10 is shown in FIG. 8 and is represented by reference numeral 310. In this embodiment of the present invention, elements that correspond to elements in the first embodiment (signal processing device 10) are represented by reference numerals increased by factors of 300. In the interest of brevity, some features of this embodiment that are shared with the first embodiment may be numbered in FIG. 8, but are not repeated in the specification.

In this embodiment, the alpha video signal 336 is projected by a video projector 396 through an alpha polarizing filter 398 and onto a display surface 363. Similarly, the beta video signal 338 is projected by a video projector 397 through a beta polarizing filter 399 and onto the same display surface 363. The orientations of the alpha and beta polarizing filters 398, 399 are preferably offset by about ninety degrees.

Alpha polarized glasses 370, having an orientation matching the alpha polarizing filter 398, are provided, which enables a viewer 1 using these glasses 370 to view the alpha video signal 336 on the display surface 363, but not the beta video signal 338. Similarly, beta polarized glasses 372, having an orientation matching the alpha polarizing filter 399, are provided, which enables another viewer 2 using these glasses 372 to view the beta video signal 338 on the display surface 363, but not the alpha video signal 336. In the relative orientations between the polarized glasses 370, 372 and polarizing filters 398, 399, as described above, assume that the glasses 370, 372 are in the position that they would be in when worn by a person in an upright position.

In this embodiment, the polarizing filters 398, 399 each preferably comprise a linear polarizing film, such as a Cellulose Acetate Butyrate (CAB) laminated film. This embodiment could also be adapted to use a circular polarizing film.

As in the first embodiment, the alpha and beta audio signals 332, 334 are separated from the multi-channel signals 324, 326 by the tuners 328, 330 and passed to a multi-channel RF transmitter 380. The RF transmitter 380 transmits alpha and beta RF audio signals 382, 384 to alpha and beta headphones 385, 386, respectively.

Due to the use of the polarizing filters 398, 399 and the polarized glasses 370, 372, it is not necessary to interlace the alpha and beta video signals 336, 338 in order to enable viewers to view only one of the two signals. Viewing quality could be improved, however, by interlacing the alpha and beta video signals 336, 338 using any of the interlacing methods described herein. Alternatively, the time multiplexing method described herein in the first embodiment and second alternate embodiment could be modified to control the light intensity of the projectors, so that the light of the alpha and beta projectors shine alternately. This will result in improved image differentiability.

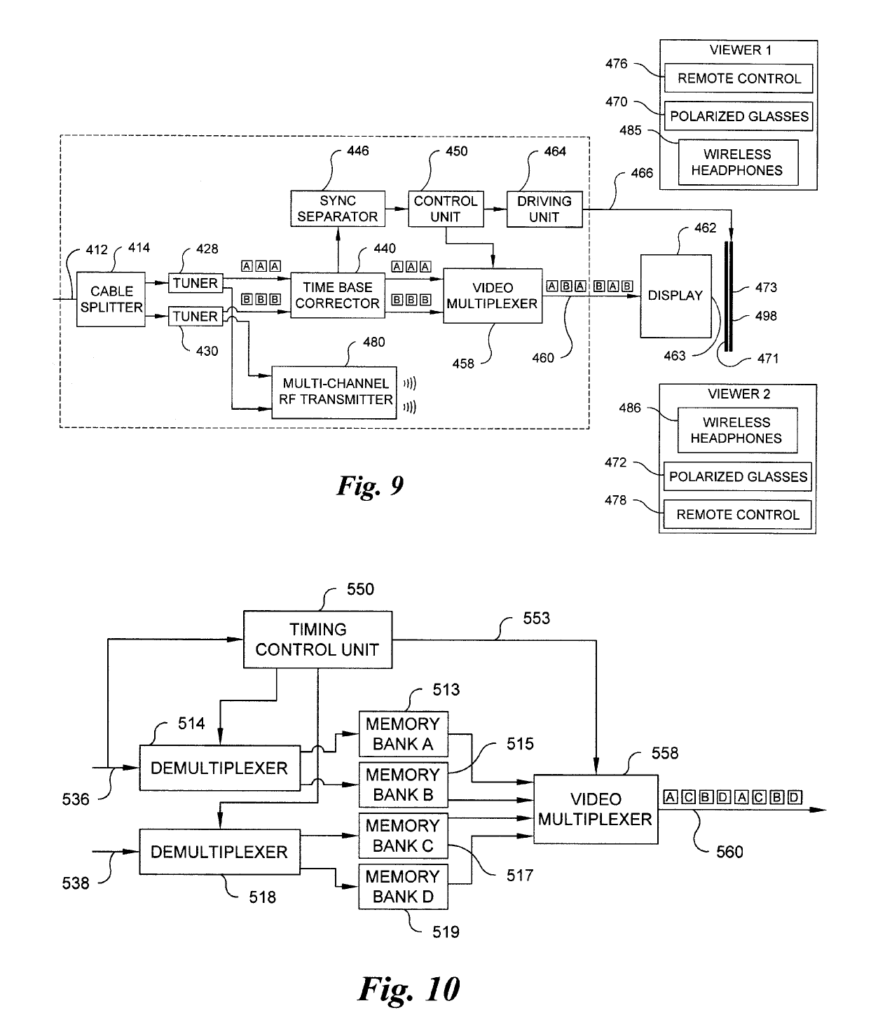

A fifth embodiment of the signal processing device 10 is shown in FIG. 9 and is represented by reference numeral 410. In this embodiment of the present invention, elements that correspond to elements in the first embodiment (signal processing device 10) are represented by reference numerals increased by factors of 400. In the interest of brevity, some features of this embodiment that are shared with the first embodiment may be numbered in FIG. 9, but are not repeated in the specification.

The signal-splitting, tuning, synchronizing and interlacing functions of this embodiment are identical to the first embodiment. In this embodiment, a polarizer 498 is placed in front of the display surface 463 and viewers wear alpha and beta polarized glasses 470, 472, as in the fourth embodiment. The polarizer 498 comprises a polarizing layer 471 and a twisted nematic liquid crystal layer 473.

When no electric current is applied to the twisted nematic liquid crystal layer, the axis of polarization of the light passing through the polarizer 498 is the orientation polarizing layer 471 (hereinafter “alpha orientation”). When an electric current is applied to the twisted nematic liquid crystal layer 471, the axis of polarization of the light passing through the polarizer 498 is rotated by about 90 degrees (hereinafter “beta orientation”). This configuration could, obviously, be reversed.

Electric current to the twisted nematic liquid crystal layer 471 is controlled by the driving unit 464, which preferably generates a square wave control signal 466 that alternates between zero and ten volts (like the shutter A control signal shown in FIG. 5). The control signal 466 is synchronized with the interlaced output signal 460, like the alpha shutter control signal 54 and the interlaced output signal 60 of the first embodiment.

The alpha polarized glasses 470 are oriented so that, when in an upright position, they match the orientation of the axis of polarization of the interlaced output signal 60 in the alpha orientation after passing through the polarizer 498. Similarly, the beta polarized glasses 472 are oriented so that, when in an upright position, they match the orientation of the axis of polarization of the interlaced output signal 60 in the beta orientation after passing through the polarizer 498. The orientations of the alpha and beta polarized glasses 470, 472, coupled with the timing of the control signal 466 and the interlaced output signal 460 cause a viewer (viewer 1 in FIG. 9) wearing the alpha polarized glasses 470 to only see fields from the alpha video signal and a viewer (viewer 2 in FIG. 9) wearing the beta polarized glasses 472 to only see fields from the beta video signal.

As described above with respect to the third embodiment (FIG. 6), it may be desirable to provide an interlaced output signal having a field or frame refresh rate that is double that of each of the alpha and beta input video signals. This will be referred to herein as “sync doubling.” Quad buffering is one method to achieve this result.

Another similar method of sync doubling is shown in FIG. 10. Synchronized alpha and beta video signals 536, 538 are fed to alpha and beta demultiplexers 516, 518, respectively. Typically, the alpha and beta video signals 536, 538 will have field refresh rates of 60 Hz. The alpha demultiplexer 516 sends alpha fields in alternating sequence to memory banks A and B 513, 515. Similarly, the beta demultiplexer 518 sends beta fields in alternating sequence to memory banks C and D 517, 519. The memory banks 513, 515, 517, 519 should have sufficient memory to store at least one field. A video multiplexer 558 reads the output signals of the memory banks 513, 515, 517, 519 in A-C-B-D sequence and generates an interlaced output video signal 560 having the same field sequence.

A timing control unit 550 extracts field timing information from either the alpha or beta video input signal 536, 538. The timing control unit 550 provides a timing control signal to each of the demultiplexers 516, 518, which controls the routing of fields to the memory banks 513, 515, 517, 519. Alpha fields are stored in memory banks A and B 513, 515 at the same rate as the field refresh rate of the alpha video signal 536. Similarly, beta fields are stored in memory banks C and D 517, 519 at the same rate as the field refresh rate of the beta video signal 538.

The timing control unit 550 also provides a control signal to the video multiplexer 558, which controls the rate at which fields are read from the memory banks 513, 515, 517, 519. The video multiplexer 558 preferably reads fields from the memory banks 513, 515, 517, 519 at a rate that is twice the field refresh rate of each of the alpha and beta video signals 536, 538.

This sync doubling method requires that the alpha and beta video signals 536, 538 be digital signals. If sync doubling is desired for an embodiment having analog video input and/or output, analog-to-digital and/or digital-to-analog converters can be used.

It is recognized by those skilled in the art, that changes may be made to the above-described embodiments of the invention without departing from the broad inventive concept thereof. It is understood, therefore, that this invention is not limited to the particular embodiments disclosed but is intended to cover all modifications which are in the spirit and scope of the invention.

What is claimed is:

1. An apparatus comprising:
a multiplexer that interlaces a first video signal and a second video signal to generate a third video signal, the first video signal comprising a first series of fields, the second video signal comprising a second series of fields; and
a filter system that is adapted to enable a first person, when viewing a display surface displaying the third video signal, to see the first series of fields but not the second series of fields and a second person, when viewing the display surface simultaneously with the first person, to see the second series of fields but not the first series of fields.

2. The apparatus of claim 1, wherein the third video signal is generated by field-interlacing the first video signal and the second video signal.

3. The apparatus of claim 1, wherein the third video signal is generated by frame-interlacing the first video signal and second video signal.

4. The apparatus of claim 1, wherein the filter system includes first and second eyewear, each of the first and second eyewear including at least one lens having a substantially opaque state and a substantially transparent state, wherein the at least one lens of the first eyewear is adapted to be in the substantially opaque state when any field of the second series of fields is being displayed on the display surface and in the substantially transparent state when any field of the first series of fields is being displayed on the display surface, and the at least one lens of the second eyewear is adapted to be in the substantially opaque state when any field of the first series of fields is being displayed on the display surface and in the substantially transparent state when any field of the second series of fields is being displayed on the display surface.

5. The apparatus of claim 1, further comprising an audio unit that enables the first person to hear only a first audio signal and enables the second person to hear only a second audio signal, the first and second audio signals comprising corresponding audio signals to the first and second video signals, respectively.

6. The apparatus of claim 1, further comprising a synchronizing unit that synchronizes the first and second video signals prior to interlacing of the first and second video signals by the multiplexer.

7. The apparatus of claim 1, further comprising a synch extractor that extracts timing information from at least one of the first and second video signals.

8. The apparatus of claim 7, further comprising a control unit that uses the timing information from the synch extractor to generate a control signal that indicates the beginning of a new field of the first and second series of fields, wherein the control signal is passed to the multiplexer and used by the multiplexer to interlace first and second video signals.

9. The apparatus of claim 8, wherein the control signal is also passed to the filter system.

10. The apparatus of claim 1, further comprising a first tuner that extracts the first video signal from a multi-channel video source and a second tuner that extracts the second video signal from a multi-channel video source, the first and second video signals each being single-channel video signals.

11. The apparatus of claim 10, wherein the first tuner separates a first audio signal from the multi-channel video source and the second tuner separates a second audio signal from the multi-channel video source, the first audio signal corresponding to the first video signal and the second audio signal corresponding to the second video signal.

12. The apparatus of claim 1, wherein the multiplexer comprises either an analog or a digital circuit.

13. The apparatus of claim 12, wherein the analog or digital circuit comprises a video multiplexer and an amplifier.

14. The apparatus of claim 1, wherein the multiplexer comprises software that controls the interlacing of the first and second video signals.

15. The apparatus of claim 14, wherein the multiplexer further comprises a graphics card.

16. The apparatus of claim 14, wherein the multiplexer comprises double-buffered RAM.

17. The apparatus of claim 1, wherein the first and second video signals have a first field-refresh rate and the third video signal has a third field-refresh rate, the third field-refresh rate being twice the first field-refresh rate.

18. The apparatus of claim 1, further comprising at least one processor, the at least one processor being responsive to a first set of controller signals generated by a first game controller operated by the first person and a second set of controller signals generated by a second game controller operated by the at least one processor being adapted to receive instructions from a game program and being adapted to generate game graphics, wherein the first and second video signals are generated at least in part from the game graphics.

19. The apparatus of claim 18, wherein the at least one processor comprises a main processor and a graphics co-processor, the main processor being responsive to the first and second sets of controller signals, the main processor being adapted to receive instructions from the game program, the graphics co-processor generates the game graphics.

20. The apparatus of claim 18, further comprising a video signal generating unit that converts the game graphics to the first and second video signals.

21. The apparatus of claim 1, wherein the filter system that is adapted to enable a first person, when viewing a display surface displaying the third video signal full-screen, to see the first series of fields but not the second series of fields and a second person, when viewing the display surface simultaneously with the first person, to see the second series of fields but not the first series of fields.

22. An apparatus comprising:
means for displaying first and second video signals full screen on a display surface, the first video signal comprising a first series of fields and the second video signal comprising a second series of fields, said means displaying fields from the first series of fields either simultaneously or in alternating sequence with fields from the second series of fields on a display surface; and
a filter system that is adapted to enable a first person, when viewing the display surface, to see the first series of fields but not the second series of fields and adapted to enable a second person, when viewing the display surface simultaneously with the first person, to see the second series of fields but not the first series of fields.

23. The apparatus of claim 22, wherein the filter system comprises first and second polarizers, each having an orientation, and first and second polarized eyewear, each having a viewing orientation, the orientation of the first polarizer being different than the orientation of the second polarizer, the viewing orientation of the first polarized eyewear being substantially the same as the orientation of the first polarizer, and the viewing orientation of the second polarized eyewear being substantially the same as the orientation of the second polarizer wherein the first video signal is passed through the first polarizer before being displayed on the display surface and the second video signal is passed through the second polarizer before being displayed on the display surface.

24. The apparatus of claim 23, wherein the filter system further comprises a first projector that projects the first video signal through the first polarizer and onto the display surface and a second projector that projects the second video signal through the second polarizer and onto the display surface.

25. An apparatus comprising:
a synch separator that obtains timing information from at least one of a first and second video signals, the first video signal comprising a first series of fields, the second video signal comprising a second series of fields, the first video signal having a corresponding first audio signal and the second video signal having a corresponding second audio signal;
a control unit that uses the timing information obtained by the synch separator to generate a control signal;
a multiplexer that utilizes the control signal to interlace the first video signal and the second video signal to generate a third video signal; and
a filter system that is adapted to enable a first person, when viewing a display surface displaying the third video signal, to see the first series of fields but not the second series of fields and to hear the first audio signal and not the second audio signal and a second person, when viewing the display surface simultaneously with the first person, to see the second series of fields but not the first series of fields and to hear the second audio signal and not the first audio signal.

26. The apparatus of claim 25, wherein the filter system comprises first and second eyewear, each of the first and second eyewear including at least one lens having a substantially opaque state and a substantially transparent state, wherein the at least one lens of the first eyewear is adapted to be in the substantially opaque state when any field of the second series of fields is being displayed on the display surface and in the substantially transparent state when any field of the first series of fields is being displayed on the display surface, and the at least one lens of the second eyewear is adapted to be in the substantially opaque state when any field of the first series of fields is being displayed on the display surface and in the substantially transparent state when any field of the second series of fields is being displayed on the display surface.

27. A method of displaying a first video signal having a first set of fields and a second video signal having a second set of fields, the method comprising:
interlacing the first and second video signals to form a third video signal that comprises a third series of fields, the third series of fields consisting of the first and second series of fields in alternating sequence;
filtering the third signal so that a first person, when viewing a display surface displaying the third video signal, to able to see the first series of fields but not the second series of fields and a second person, when viewing the display surface simultaneously with the first person is able to see the second series of fields but not the first series of fields.

28. The method of claim 27, further comprising:
providing an audio unit that enables the first person to hear only a first audio signal and enables the second person to hear only a second audio signal, the first and second audio signals comprising corresponding audio signals to the first and second video signals, respectively.

29. The method of claim 27, further comprising extracting the first and second video signals from a multi-channel signal source.

30. The method of claim 29, further comprising extracting first and second audio signals from the multi-channel signal source.

31. The method of claim 30, further comprising synchronizing the first and second video signals.

32. The method of claim 27, further comprising extracting timing information from the first and second video signals.
